(19) United States
(12) Patent Application Publication
(10) Pub. No.: US 2011/0036960 A1
(43) Pub. Date: Feb. 17, 2011

(54) CONNECTION DEVICE

(75) Inventor: Zhan-Yang LI, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/629,610

(22) Filed: Dec. 2, 2009

(30) Foreign Application Priority Data
Aug. 17, 2009 (CN) 200910305711.9

(51) Int. Cl. F16M 13/00

(52) U.S. Cl. 248/288.31; 248/288.11

(57) ABSTRACT

A connection device includes a rotatable member and a securing member. The rotatable member includes a connecting block and a post attached to the connecting block. The post is configured for being secured to a first device. The securing member is configured for being secured to a second device and defines a first cover opening and a second cover opening. The first cover opening is in communication with the second cover opening. The rotatable member is rotatable relative to the securing member, and the post is slidable in the first and second cover openings.

### BACKGROUND

1. Technical Field

The present disclosure relates to connection devices, and particularly to a connection device connecting an electronic device and a display device.

2. Description of Related Art

Often, a display device is electronically connected to a computer host. However, the display device is rotatable relative to the computer host only about a shaft.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric, cutaway view of an embodiment of a connection device.

FIG. 2 is an assembled view of the connection device shown FIG. 1.

FIG. 3 is an exploded, isometric view of a connection device, an electronic device and a display device of an embodiment.

FIG. 4 is an assembled view of the embodiment shown FIG. 3.

FIG. 5 is similar to FIG. 4, but in a different position.

FIG. 6 is similar to FIG. 5, but in a different position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

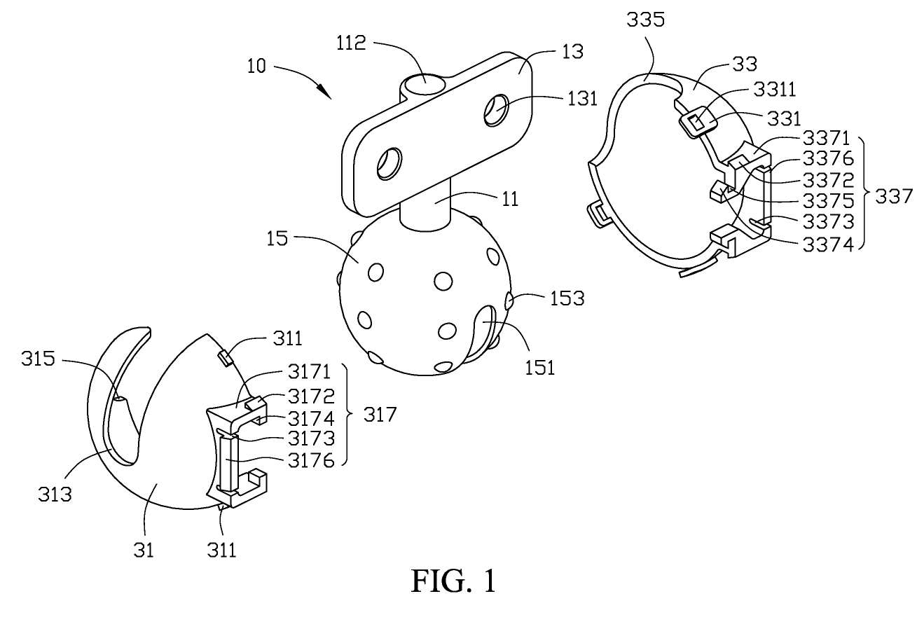

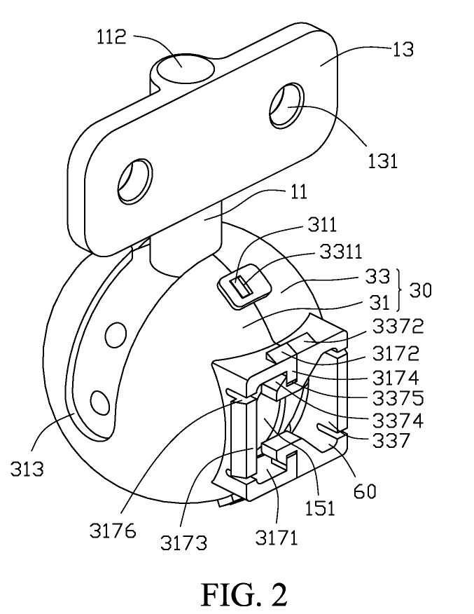

Referring to FIG. 1, a connection device in accordance with an embodiment includes a rotatable member 10 and a securing member 30 (shown in FIG. 2) configured for receiving the rotatable member 10.

The rotatable member 10 includes a post 11, a mounting board 13, and a connecting block 15. A post hole 112 is defined in the post 11. The mounting board 13 is fixed on the post 11 adjacent to an end of the post 11. Two mounting holes 131 are defined in the mounting board 13. The connecting block 15 is secured at another end of the post 11. An elongated block opening 151 is defined in the connecting block 15 and in communication with the post hole 112. A plurality of resiliently deformable block protrusions 153 is located on an outer surface of the connecting block 15. In one embodiment, the connecting block 15 is spherical.

The securing member 30 includes a first cover 31 and a second cover 33 configured for attaching to the first cover 31. In one embodiment, the first cover 31 and the second cover 33 are hemispherical.

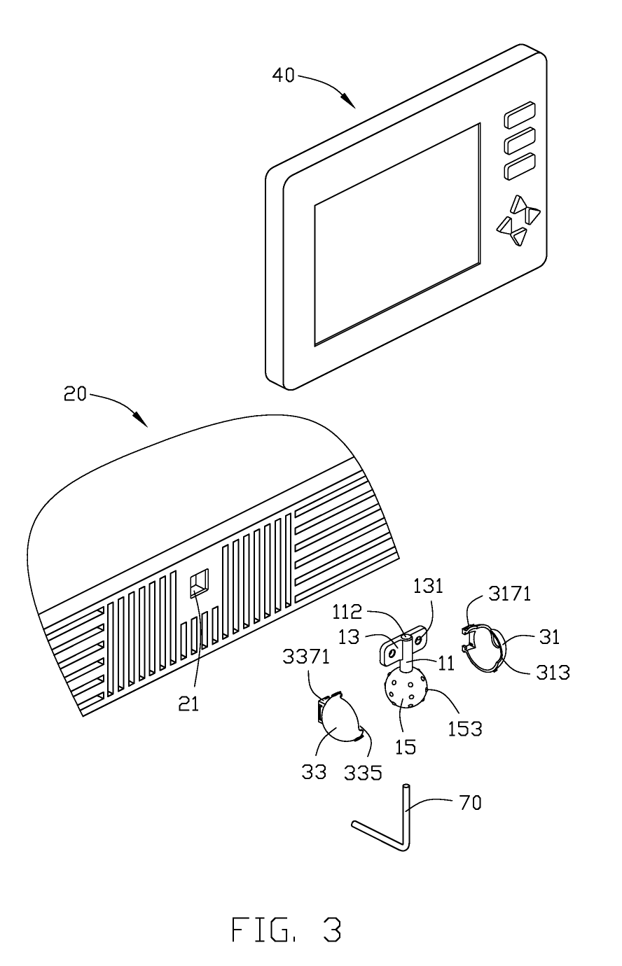

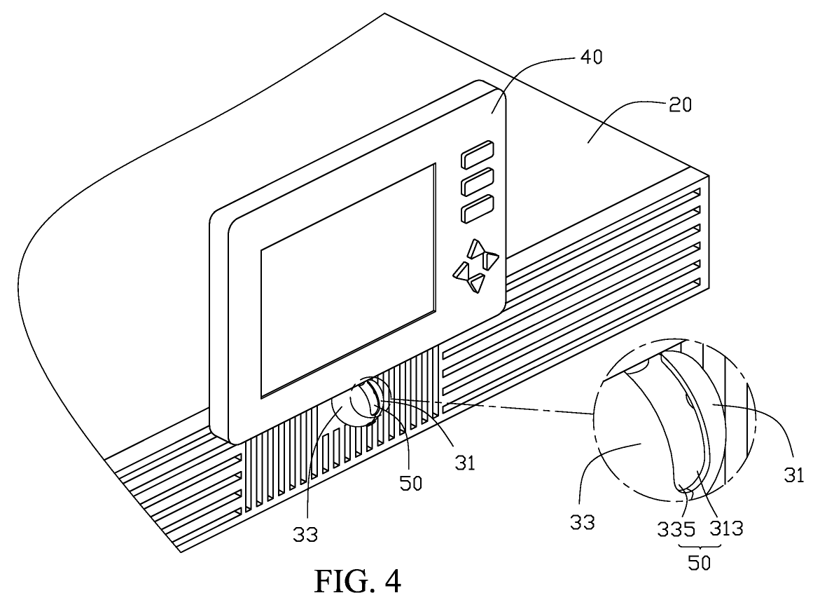

Three cover tabs 311 are located on an outer surface of the first cover 31, arranged at equal intervals from each other. A first cover opening 313 and a first cover cutout 315 (better shown in FIGS. 3-4) are defined in the first cover 31 and in communication with each other. A first cover portion 317 is located on the outer surface of the first cover 31 adjacent to the edge of the first cover 31. The first cover portion 317 includes two parallel first cover portion walls 3171. A first latch 3172 is located on an outer surface of each first cover portion wall 3171, and a stop 3174 is located on an inner surface of each first cover portion wall 3171. A first hook 3176 is located on the first cover portion 317, and two first cover portion slits 3173 are defined between the first hook 3176 and the two first cover portion walls 3171, and are configured to resiliently deform the second hook 3176.

Three cover locks 331 are located on an outer surface of the second cover 33, and arranged at equal intervals from each other. A lock hole 3311 is defined in each cover lock 331. A second cover cutout 335 is defined in an edge of the second cover 33. A second cover portion 337 is located on the outer surface of the second cover 33. The second cover portion 337 includes two parallel second cover portion walls 3371. A second latch 3372 is located on an outer surface of each second cover portion wall 3371, and a resilient deformable hook 3374 extends from an inner surface of each second cover portion wall 3371. A hook slot 3375 is defined in each deformable hook 3374 for receiving the stop 3174 of the first cover 31. A second hook 3376 has a structure similar to the first hook 3176 and is located on the second cover portion 337. Two second cover portion slits 3373 are defined between the second hook 3376 and the second cover wall 3371, and are configured to resiliently deform the second hook 3376.

Referring also to FIG. 2, in assembly of the connection device, the connecting block 15 is positioned in the first cover 31 and the second cover 33. The first cover 31 is positioned on the second cover 33. The cover tabs 311 are engaged in the lock holes 3311 of the second locks 331. The first cover cutout 315 is in communication with the second cover cutout 335, to define a second cover opening 50 (better shown in FIG. 4), which is in communication with the first cover opening 313. A cover slot 60 is defined between the first and second cover portions 317, 337 and in communication with the first and second cover openings 313, 50. The stop 3174 of the first cover 31 is engaged in the hook slot 3375, and engaged with the deformable hook 3374 of the second cover 33. Therefore, the rotatable member 10, the first cover 31 and the second cover 33 are secured. The rotatable member 10 is rotatable relative to the securing member 30. The post 11 is slidable in the first cover opening 313 and the second cover opening 50. In one embodiment, the first and second covers 31, 33 are hemispherical, so the securing member 30 is generally spherical, and the first and second openings 313, 50 are defined in two spherical circles of the securing member 30.

Referring also to FIG. 3, the connection device is configured to be secured to an electronic device 20 and a display device 40. The electronic device 20 may be, for example, a personal computer, or a server, etc. A plate hole 20 is defined in the electronic device 20. Securing holes (not shown) are defined in a back surface of the display device 40 corresponding to the mounting holes 131 of the connection device.

Referring also to FIG. 3, in assembling the connection device to the electronic device 20 and the display device 40, the first and second latches 3172, 3372 and the first and second hooks 3176, 3376 of the securing member 30 are engaged in the plate hole 21 of the electronic device 20, so as to secure the connection device on the electronic device 20. The two securing holes of the display device 40 are aligned with the mounting holes 131 of the connection device, and two fasteners are fixed in the securing holes and the mounting holes 131, so as to secure the display device 40 on the mounting bard 13 of the connection device. In addition, a cable 70 (shown in FIG. 3) can be positioned in the post hole 112, the block opening 151, and the cover slot 60. Via the cable 70, the display device 40 electrically connects with the electronic device 20.

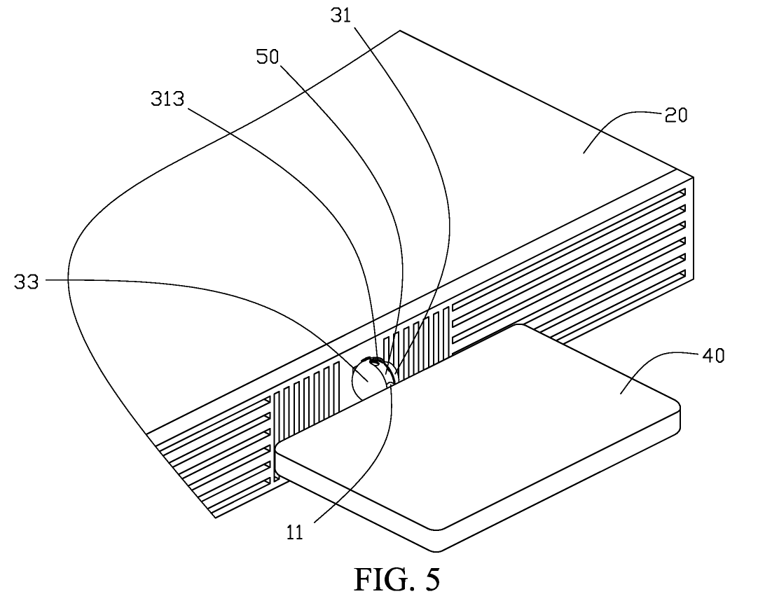

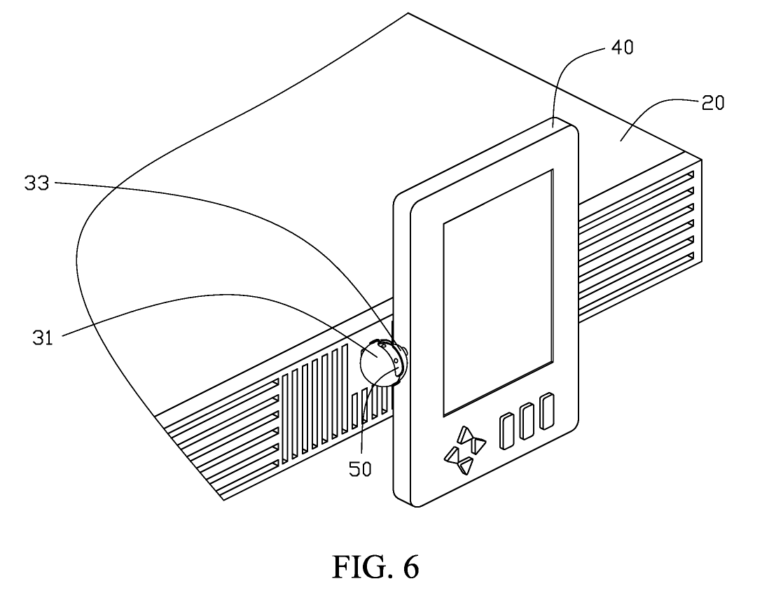

Referring also to FIGS. 4-5, the rotatable member 10 is rotatable in a first plane (not shown) from a first position, where the first cover opening 313 joins the second cover opening 50, to a first position, where the post 11 is blocked by an end of the second cover opening 50. Referring also to FIGS. 4 and 6, the rotatable member 10 is rotatable in a second plane (not shown) from the first position to a third position, where the post 11 is blocked by an end of the first cover opening 50. In one embodiment, the first plane is generally perpendicular to the second plane.

In addition, the display device 40 is capable of rotating about an axis of the post 11 of the securing member 10. The block protrusions 153 engage with the inner surfaces of the first and second covers 31, 33, so as to position the display device 40 in a desired position during rotation thereof.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A connection device comprising:
a rotatable member comprising a connecting block and a post attached to the connecting block, the post configured for being secured to a first device; and
a securing member configured for being secured to a second device, receiving the connecting block, and defining a first cover opening and a second cover opening; the first cover opening being in communication with the second cover opening;
wherein the rotatable member is rotatable relative to the securing member, and the post is slidable in the first and second cover openings.

2. The connection device of claim 1, wherein a plurality of blocking protrusions is located on the connecting block and engages an inner surface of the securing member.

3. The connection device of claim 1, wherein the post defines a post hole and the connecting block defines a block opening in communication with the post hole.

4. The connection device of claim 1, wherein the securing member defines a cover slot in communication with a block opening.

5. The connection device of claim 1, wherein the securing member comprises a first cover and a second cover secured to the first cover, and the connecting block is enclosed by the first and second covers.

6. The connection device of claim 5, wherein the first cover defines a first cover cutout and the second cover defines a second cover cutout, and the first cover cutout and the second cover cutout define the second cover opening when the first cover is secured on the second cover.

7. The connection device of claim 5, wherein a plurality of cover tabs is located on the first cover; a plurality of cover locks each with a lock hole is located on the second cover; wherein the tabs are engaged in the lock holes.

8. The connection device of claim 5, wherein a first cover portion is located on the first cover; a stop is located on the first cover portion; a second cover portion is located on the second cover; a deformable hook is located on the second cover portion, and is engageable with the stop of the first cover portion.

9. The connection device of claim 5, wherein the connecting block is spherical and the first and second covers are hemispherical.

10. A connection device comprising:
a rotatable member comprising a connecting block and a post attached to the connecting block, the post being configured for being secured to a first device; and
a securing member configured for being secured to a second device, rotatably receiving the connecting block, and defining a cover opening; the cover opening receiving the post; wherein
the connecting block is rotatable about the post and rotatable to slide the post in the cover opening.

11. The connection device of claim 10, wherein a plurality of blocking protrusions is located on the connecting block and engages an inner surface of the securing member.

12. The connection device of claim 10, wherein the post defines a post hole and the connecting block defines a block opening in communication with the post hole.

13. The connection device of claim 12, wherein the securing member defines a cover slot in communication with the block opening.

14. The connection device of claim 10, wherein the securing member comprises a first cover and a second cover secured to the first cover, and the connecting block is enclosed by the first and second covers.

15. The connection device of claim 14, wherein the first cover defines a first cover cutout; the second cover defines a second cover cutout, and the first cover cutout and the second cover cutout define the cover opening.

16. The connection device of claim 14, wherein a plurality of cover tabs is located on the first cover; a plurality of cover locks, each with a lock hole, is located on the second cover; and the tabs are engaged in the lock holes.

17. The connection device of claim 15, wherein a first cover portion is located on the first cover; a stop is located on the first cover portion; a second cover portion is located on the second cover; and a deformable hook is located on the second cover portion, and is engageable with the stop of the first cover portion.

18. A connection device configured for connecting a first device and a second device, the connection device comprising:
a rotatable member comprising a connecting block and a post located on the connecting block; the connecting block defining a block opening; the post configured for being secured to the first device, defining a post hole in communication with the block opening; the block opening and the post hole configured for receiving a cable electronically connected to the first device and the second device; and
a securing member configured for being secured to the other of the second device, rotatably receiving the connecting block, and defining a cover slot in communication with the blocking opening and configured for the cable to pass therethrough; wherein
the connecting block is rotatable about the axis and the post and the connecting block are rotatable about the center of the connecting block.

19. The connection device of claim 18, wherein a plurality of blocking protrusions are located on the connecting block and engage an inner surface of the securing member.

20. The connection device of claim 18, wherein the securing member comprises a first cover and a second cover secured on the first cover, and the connecting block is enclosed by the first and second covers.
